(19) United States
(12) Patent Application Publication
(10) Pub. No.: US 2020/0367443 A1
(43) Pub. Date: Nov. 26, 2020

(54) Horticulture Grow System for Horticulture

(71) Applicants: Darrin Dow, Sisters, OR (US); Douglas Moir, Bend, OR (US)

(72) Inventors: Darrin Dow, Sisters, OR (US); Douglas Moir, Bend, OR (US)

(21) Appl. No.: 16/880,849

(22) Filed: May 21, 2020

Related U.S. Application Data
(60) Provisional application No. 62/851,109, filed on May 22, 2019.
(60) Provisional application No. 62/873,786, filed on Jul. 12, 2019.

(51) Int. Cl. A01G 7/04; A01G 31/02; A01G 9/02; A01G 9/24

(52) U.S. Cl. CPC A01G 7/045; A01G 9/247; A01G 9/027; A01G 31/02

(57) ABSTRACT

In some implementations, an indoor grow system for plants includes at least a plant substrate system; a luminaire positioned adjacent to the plant substrate system, the luminaire includes a plurality of grow light panels, a lighting frame, and at least one luminaire connector, the lighting frame includes a plurality of frame members, the at least one luminaire connector is coupled between one frame member and another frame member adjacent to the one frame member, the luminaire connector adjusts the spatial position of the plurality of frame members that define the lighting frame and shape of the luminaire; and a plant canopy zone, defined between the plant substrate system and the luminaire rendered in a curvilinear configuration, and whereby the plant canopy zone defines a curvilinear space for illuminating the plants.

### PRIORITY APPLICATIONS

This application claims priority to U.S. Provisional Application No. 62/851,109 entitled “Pyramid Semi Circle Horticulture Grow System” and filed May 22, 2019 and to U.S. Provisional Application No. 62/873,786 entitled “Pyramid Curved Horticulture Grow System” and filed Jul. 12, 2019. Both of the above applications are hereby incorporated by reference in their entireties.

### TECHNICAL FIELD

Implementations described herein relate to a horticultural grow system that includes at least a plant substrate system and a luminaire. In particular, some implementations relate to a grow system that includes at least that includes at least a plant substrate system and a luminaire that is configured to be powered with direct current.

### BACKGROUND

Recently there has been an increase in indoor growing of plants for markets. Among the plants grown in grow rooms indoors are lettuce, some salad greens, strawberries, mint, basil, and cannabis. Some of these plants require large amounts of light. Providing this large amount of light is often performed using various lighting systems deployed above a plant canopy in the grow rooms.

### SUMMARY

The following summary introduces at a high level a limited number of topics described in the Detailed Description. This summary is not intended to identify key or essential features and should not be used for that purpose. In addition, this summary is not intended to be used as a guide to the scope of the claims. Instead, this Summary is provided as an introduction for the reader.

In an exemplary first implementation, a horticulture grow system for plants includes at least a plant substrate system.

The horticulture grow system for plants of the first exemplary implementation further includes at a luminaire positioned adjacent to the plant substrate system, the luminaire includes a plurality of grow light panels, a lighting frame, and at least one luminaire connector, the lighting frame includes a plurality of frame members, the at least one luminaire connector is coupled between one frame member and another frame member adjacent to the one frame member, the luminaire connector adjusts the spatial position of the plurality of frame members that define the lighting frame and shape of the luminaire.

The horticulture grow system for plants of the first exemplary implementation further includes at a plant canopy zone, defined between the plant substrate system and the light canopy rendered in a curvilinear configuration, and whereby the plant canopy zone defines a curvilinear space for illuminating the plants.

In a second exemplary implementation, a horticulture grow system for plants includes at least a plant substrate system.

The horticulture grow system of the second exemplary implementation further including at least a light canopy positioned adjacent to the plant substrate system, the light canopy includes a plurality of grow light panels, a lighting frame, and at least one canopy connector, the canopy connector adjusts the spatial position of frame members that define the lighting frame and curvilinear shape of the light canopy.

In a third exemplary implementation, a method of illumination includes a plurality of steps, including at least disposing plants hydroponically on a plant substrate system.

The method of illumination of the third exemplary implementation further includes at least positioning a light canopy adjacent to the plant substrate system to define a plant canopy zone, the light canopy includes a plurality of grow light panels, a lighting frame having a plurality of frame members, and at least one canopy connector;

The method of illumination of the third exemplary implementation further includes at least adjusting the spatial positions of frame members of the plurality of frame members to render the light canopy in a curvilinear shape; and

The method of illumination of the third exemplary implementation further includes at least supplying light to the plants within the plant canopy zone with the light canopy rendered in a curvilinear shape.

### BRIEF DESCRIPTION OF THE DRAWINGS

FIG. 1 is a perspective drawing of a horticulture grow system, consistent with some implementations, showing a luminaire and a plant substrate system, the luminaire configured in a curvilinear configuration.

FIG. 2 is a perspective drawing with a bottom view of the luminaire of FIG. 1, consistent with some implementations, showing a view that includes individual light units disposed on the underside of the luminaire.

FIG. 3 is a perspective drawing with a bottom-side perspective view of the luminaire of FIG. 1, consistent with some implementations, showing the underside of the luminaire in the curvilinear configuration, including at least frame members and luminaire connectors.

FIG. 4 is a perspective drawing with a top view of the luminaire of FIG. 1, consistent with some implementations, showing the top of the luminaire including at least a supply line and the top of grow light panels.

FIG. 5 is a perspective drawing with a top-side view of the luminaire of FIG. 1 in two different configurations consistent with some implementations. Drawing 5a showing the luminaire in a curvilinear configuration and Drawing 5b showing the luminaire in the somewhat straight configuration.

FIG. 6 is a partially exploded perspective view with a top-side view of the luminaire of FIG. 1, consistent with some implementations, with a pair of luminaire connecters in exploded view. An Area C to be shown enlarged in FIG. 7 is indicated.

FIG. 7 is a close-up view of Area C from in FIG. 6, consistent with some implementations, showing an exploded close-up view of a luminaire connector.

FIG. 8 is a cross-sectional two-dimensional view of an area proximate to a luminaire connector of the luminaire of FIG. 1, consistent with some implementations, showing at least a frame wall, an anchor portion, and a power line.

FIG. 9 is a close-up view of a luminaire connector of the luminaire of FIG. 1, consistent with some implementations, showing a connector adjustment with predetermined settings.

FIG. 10 is a cross-sectional two-dimensional view of an area proximate to a luminaire connector of the luminaire of FIG. 1, showing a close-up of a luminaire connector configured with an actuator.

FIG. 11 is an electrical schematic drawing of the luminaire of FIG. 1, consistent with some embodiments, showing electrical circuitry for the luminaire.

FIG. 12 is a method flow diagram for an exemplary method of illumination, consistent with some embodiments.

### DETAILED DESCRIPTION

Some implementations are now described with reference to the above-described drawings. All implementations discussed in this detailed description and in the drawings are merely examples and not meant as limitations on the scope of the description or the claims. The drawings are simplified drawings. Some details are omitted to avoid unnecessary clutter that could obscure the principles described herein. In addition, the drawings are not necessarily to scale.

At various places in this description, there is reference to “some implementations.” These multiple references to “some implementations” are not necessarily describing the same implementations and some implementations may be alternatives to one another. Similarly, multiple references to “one embodiment” or “one exemplary embodiment” are not necessarily referring to the same embodiment. In addition, no attempt is made to exhaustively describe all possible implementations. Instead, based on the following description those of ordinary skill in the art will be appraised of certain concepts and principles which will then enable them to imagine additional or alternative implementations to those described herein.

The indoor horticulture described in this disclosure includes use of a variety of different mediums. Some example grow systems use at least one of aeroponics or hydroponics. Aeroponics is a process of growing plants with their roots in air rather than in soil or other medium. Aeroponics is a subset of hydroponics in that in aeroponics nutrients are carried via water. Examples of other plant substrates used in a plant substrate system are soil, coco, or peat moss.

Some implementations described herein include a plant substrate system that supports plants in a pyramid-shaped configuration in which they occupy less horizontal space in a grow chamber. In some implementations the plant substrate system includes grow decks for supporting plants, the grow decks arranged in the pyramid-shaped configuration. The plants supported on the grow decks extend roots below the grow decks into a grow chamber defined under the pyramid configuration of grow decks. In some implementations the roots can then be irrigated with a nozzle system disposed in the grow chamber. Some plant substrate systems may not include one or more of the above features.

Some implementations include a luminaire that is positioned to provide light through a plant canopy zone onto plants disposed on a plant substrate system. The luminaire is both light weight and flexible so it can be deployed over plant substrate systems of different configurations—including the pyramid-shaped configuration discussed above. In some implementations, a plurality of grow light panels is arranged on a lighting frame of the luminaire. And the flexibility is due at least in part to luminaire connectors that connect frame members of the lighting frame. These luminaire connectors allow the lighting frame to be arranged in different configurations as needed. Thus, the luminaire, and its grow light panels, can be arranged in shapes dependent on the shape of the plant substrate system that the luminaire is disposed over. Possible luminaire shapes include at least curvilinear, flat, concave, irregular, and other shapes. In some implementations the panels can be wired to each other without the need for luminaire connectors.

In some implementations, the luminaire includes a plurality of grow light panels powered by direct current with the direct current being distributed among the plurality of grow light panels in series. The use of direct current distributed in series allows for reduced wiring which requires less weight and less space. Thus, the installed cost of the luminaire is reduced compared to other light structures. Further, powering light panels with direct current allows the power equipment to be located in its own room far from the grow chamber, which reduces the amount of HVAC needed to maintain a grow chamber environment.

In some implementations, the luminaire connectors discussed above are configured with a passage for a direct current power line, such as discussed above. The different frame members are associated with different ones of the plurality of grow light frames. And the power line may pass through the interior of the frame members and then pass from frame member to frame member via passages in the luminaire connectors. Thus, the luminaire connectors enable a low weight direct current power line to be threaded from frame member to frame member to service the grow light panels associated with the different frame members. When panels in a luminaire are wired in series, a failure of LED or one string of LEDs does not affect the other LEDs in the luminaire to the same extent as if the panels were wired in parallel.

### First System Implementation

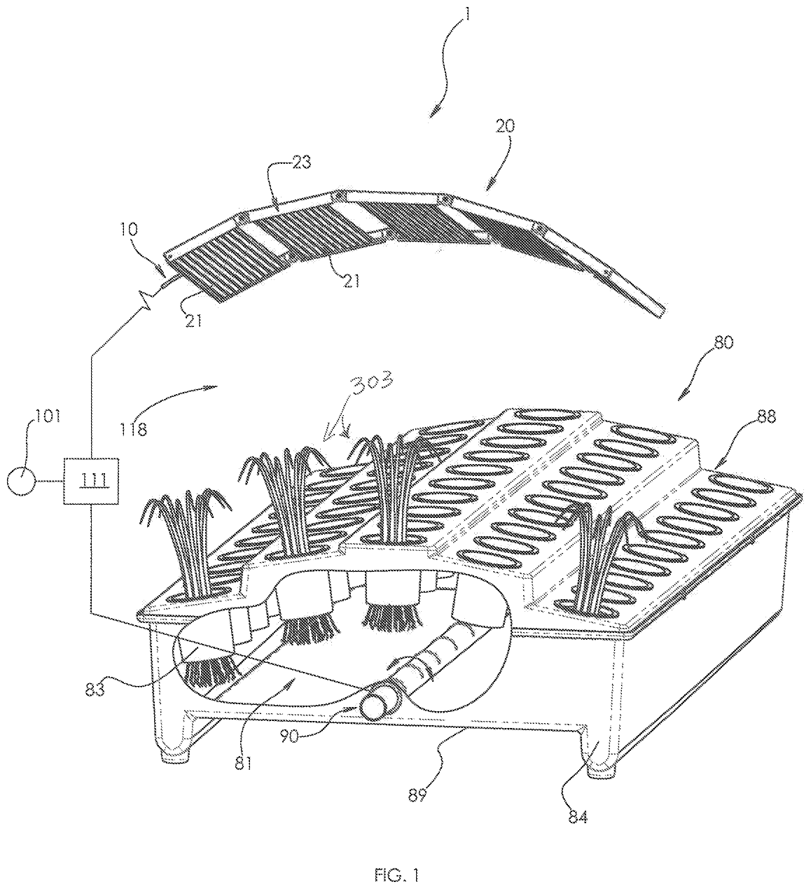

Specifically, FIG. 1 illustrates a horticulture grow system 1 for plant 303 horticulture. The horticulture grow system 1 includes a plant substrate system 80, a luminaire 20 positioned adjacent to the plant substrate system 80, and a plant canopy zone 118 defined between the plant substrate system 80 and the luminaire 20 rendered in a curvilinear configuration. As shown in FIG. 1. the plant canopy zone 118 defines a curvilinear space for illuminating the plants 303. In various embodiments a plant substrate system uses at least one of soil, coco, peat moss, hydroponics or aeroponics methods.

In one exemplary embodiment, the luminaire comprises either a light emitting diode (LED) light; a curved light; an LED light; a curved LED grow light; or a curved LED lighting frame.

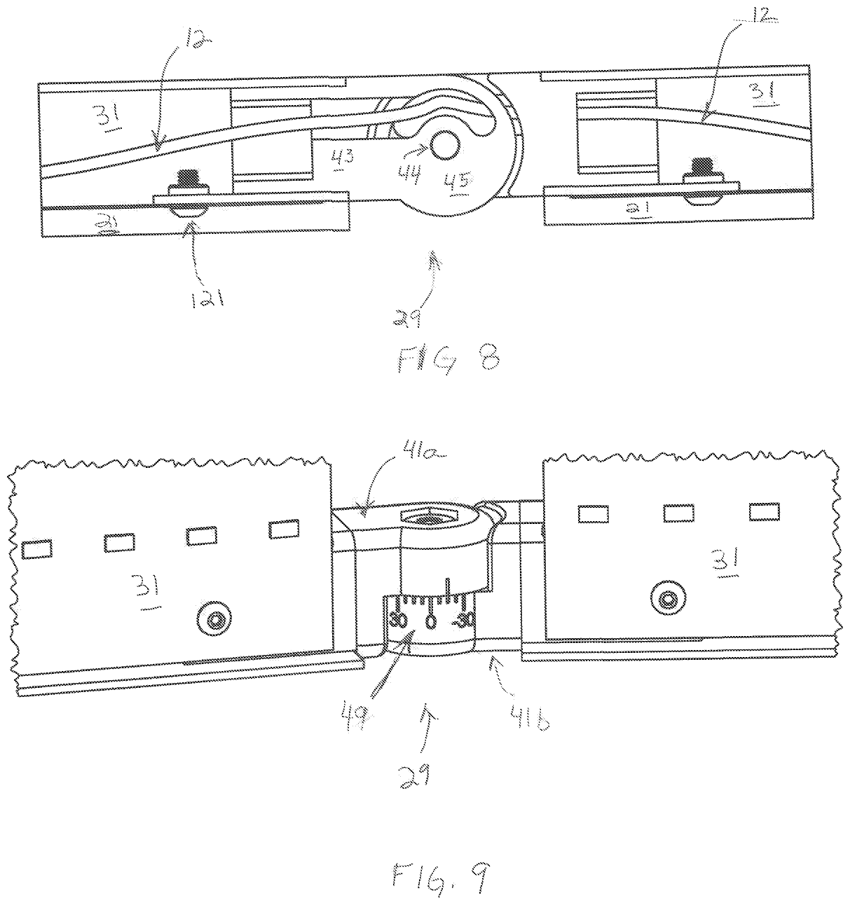

Referring to FIGS. 1, 2, 4, and 7, the luminaire 20 includes a plurality of grow light panels 21, a lighting frame 23, and at least one luminaire connector 29. The lighting frame 23 includes a plurality of frame members 28. In one exemplary embodiment shown in FIG. 7, the at least one luminaire connector 29 is coupled is coupled between one frame member and another frame member adjacent to the one frame member. Accordingly, in operation, the luminaire connector 29 adjusts the plurality of adjacent frame members 28 that defines the lighting frame 23 and shape of the luminaire 20. Possible luminaire shapes include at least one of a curvilinear shape, a flat shape, a concave shape, a shape with jigs and jags, an irregular shape or other shape.

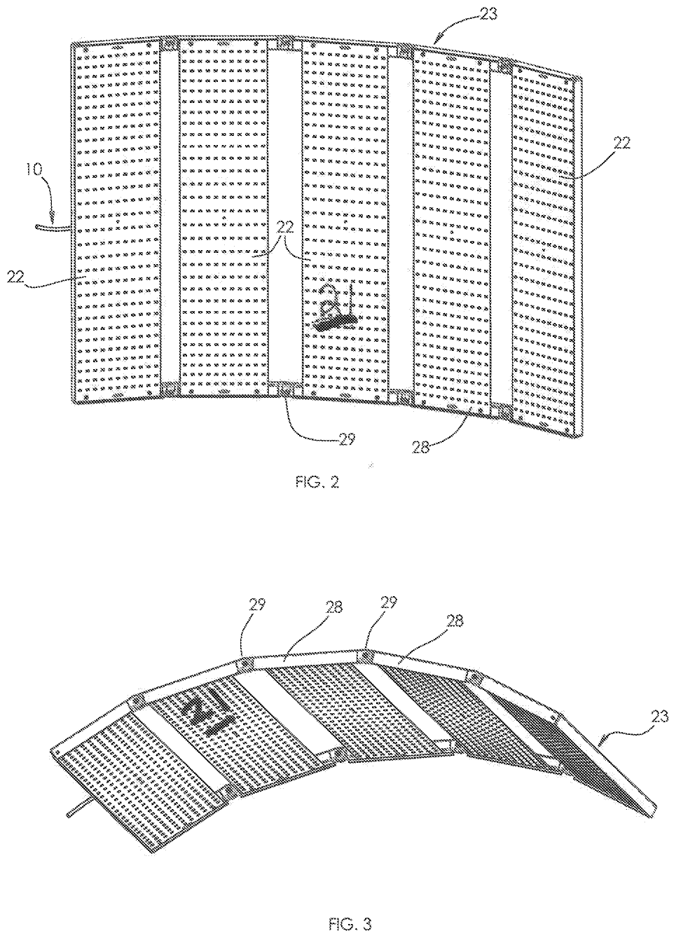

FIGS. 2 and 3 illustrate light units 22 disposed on each grow light panel 21. In one embodiment the light units 22 comprise an array of LED lights. Those of ordinary skill in the art will readily recognize the light units 22 may be configured to optimize illumination of the plants 303 from each grow light panel 21. In this description and appended claims the term “grow light panel” is defined to include among others at least one lighting panel.

Opposing, FIGS. 4-6 show reverse side of the luminaire 20 without the light units 22. As shown, the grow light panel 21 includes at least one anchor unit 24. In operation, the at least one anchor unit 24 receives an positioning element (not shown) to place the luminaire 20 adjacent to the plant substrate system 80 thereby establishing a plant canopy zone 118 there between. In some embodiments there are no anchor units because these are optional.

In FIGS. 1, 2, and 7, the horticulture grow system 1 includes a supply line 10 and a control system 111 coupled to the supply line 10. In one embodiment, the supply line 10 includes a power line 12. In operation, a power source 101, such as among others a direct current, DC, source, is coupled to the power line 12 to supply electric power through the power line 12 to the luminaire 20 and to the plant substrate system 80. FIG. 7 shows the power line 12 passing through the one frame member and another frame member adjacent to the one frame member. In one embodiment, the power line 12 passes through the plurality of frame members 28 in series. Moreover, as shown, the power line 12 passes through the at least one luminaire connector 29.

Referring back to FIGS. 4-6, in one exemplary embodiment, the supply line 10 is coupled to a line interface 11 provided by the luminaire 20. In operation, this single line interface facilitates greater ease of use and limits the overall weight of the luminaire 20 by reducing the need for further wiring. Furthermore, for making the lighting frame 30 light weight, each frame member of the plurality of frame members comprise tubing having a corresponding frame wall 31 shown in FIG. 7.

Shown in FIGS. 1 and 7, in one embodiment, the supply line 10 further includes a network line 112. The network line 112 is coupled to a control system 111. As shown, the control system 111 is coupled to the power source 101 and the luminaire 20. In operation, the control system 111 and the luminaire 20 send and receive data signals to one another that includes among others control signals for adjusting the light units 21, the electric current through the power line 12, and the spatial positioning of the luminaire 20 to the at least one luminaire connector 29 as discussed below. In one embodiment, the data signals comprise Internet protocol signals for remote control of the luminaire via an online software. Accordingly, in one embodiment, the supply line 10 provides control signals to the luminaire 20.

Further referring to FIG. 1, in one embodiment the plant substrate system 20 includes a nozzle system 90 that is coupled to the control system 111 via the supply line 10. Illustratively, the control system 10, via control signals, controls the rate and duration of water and nutrients ejected from the nozzle system to the roots of the plants 303 as shown. In one embodiment, the control system 10 controls the rate the nozzle system 90 rotates about the central axis of the nozzle system 90. The supply line 10 provides control signals to the nozzle system 90.

In FIG. 1 the plant substrate system 80 is formed of plant substrate walls 89. The plant substrate walls 89 define a grow chamber 81. As shown, the grow chamber 81 is an interior portion of the plant substrate system that houses the nozzle system 90. The plant substrate walls 89 define at least one grow deck 88 on the exterior portion of the plant substrate system 80. In operation, the grow decks orient the plants 303 to receive light within the plant canopy zone 118 from the adjacent, curvilinear luminaire. As shown, each of the plants 303 extend from the grow deck 88 outward through a plant holder 83 defined by the plant substrate walls 89 into the grow chamber 81. Accordingly, the roots of each plant 303 extend from the plant holder 83 so that the nozzle system 90 ejects water and nutrients directly to the roots of each plant 303.

Referring now to FIGS. 7-9, the luminaire connector 29 adjusts the spatial position of the plurality of frame members 28 that define the lighting frame and the shape of the luminaire 20. In the embodiment of FIG. 7, the luminaire connector 29 is defined by two halve portions 41. Each halve portion 41 includes an anchor portion 43 and an adjustment portion 45 extending from each halve portion 41. Each halve portion 41 is joined together at each corresponding adjustment portion 45 by a fastener 47 at a fastener receptacle 44 to define the connector 29. As shown, each anchor portion 43 is fitted and secured to a corresponding frame member 28. Specifically, the anchor portion 43 is secured to the inner frame wall 31 of the frame member 28. Moreover, shown in FIG. 8, the frame wall 31 defines a flange for receiving a grow light panel 21 thereon that is secured by a panel mount 121.

Shown in FIG. 7, a power line 12 passes through each luminaire connector 29. In one exemplary embodiment, the network line 112 passes through each luminaire connector 29 as shown.

In one embodiment, each adjustment portion 45 is rounded having a corresponding centerline. In operation, the fastener 47 joins the two halve portions 41 defining the luminaire connector 29 at the centerline. According, in one exemplary embodiment, the fastener 47 further provides a pivot point for independent rotations of the two halve portions 41 relative to one another. In this description and appended claims the term “luminaire connector” is defined to include among others hinges; and adjustable hinges.

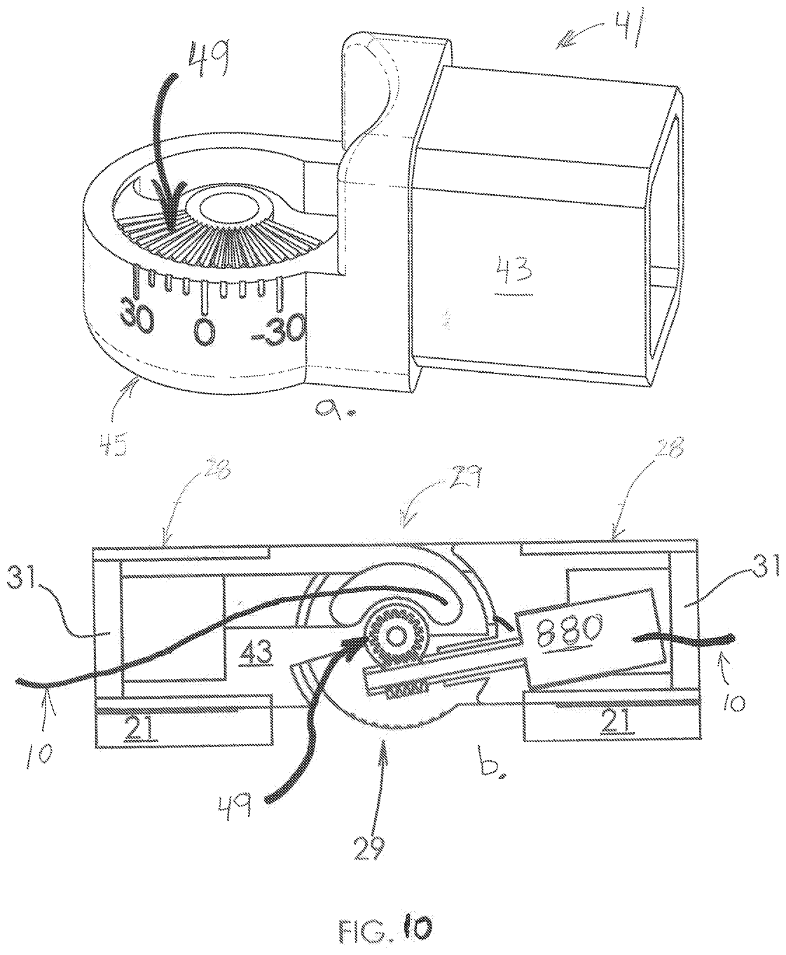

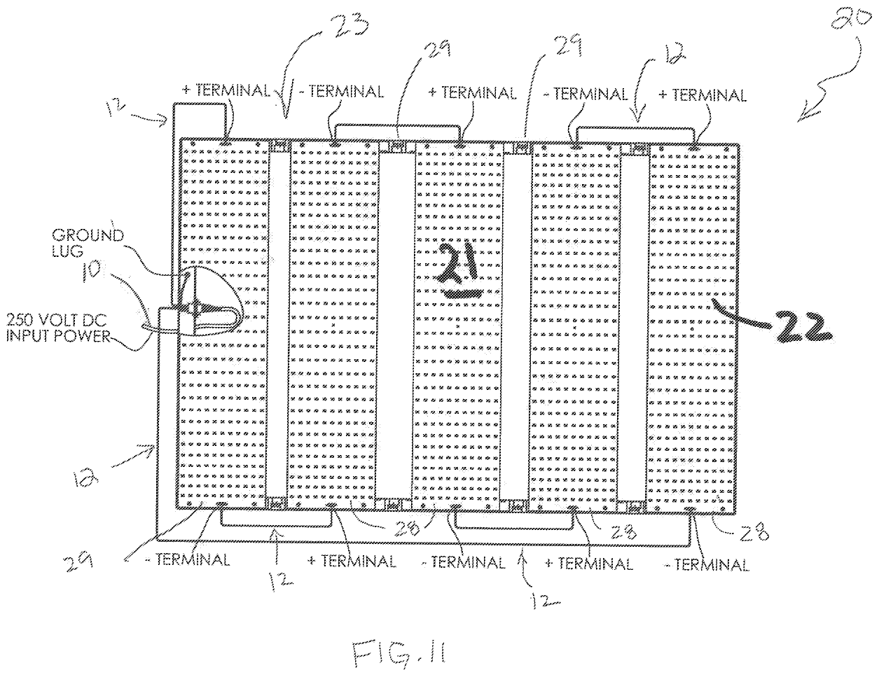

In one embodiment, shown in FIG. 9, the luminaire connector 29 further includes a connector adjustment 49. In operation, the connector adjustment 49 incrementally restricts rotational movement of the two halve portions 41 about the pivot point. The luminaire connector is configured to rotationally adjust the spatial position of each adjacent frame member. Illustratively, the connector adjustment 49 comprises a series of cams at predetermined angular distances on the mating edge of the adjustment portions 45 defining the luminaire connector 29. Accordingly, in operation, the connector adjustment 49 renders the luminaire connector 29 in predefined spatial arrangements.

In one embodiment, the luminaire connector 29 further includes an actuator 880, such as a worm gear or pneumatic actuator. As such, the luminaire connector 29 includes a first half portion and a second half portion. The actuator 880 is positioned between the first half portion and the second half portion and coupled to the supply line 10. The actuator 880 receives control signals from the supply line 10 to render the first and second half portions from a first spatial position to a second spatial position.

### Second System Implementation

In some implementations a horticulture grow system for plants includes at least a plant substrate system. For example, referencing FIG. 1a horticulture grow system (e.g. a grow system, pyramid semi-circle horticulture system, etc.) includes plant substrate system 80. Plant substrate system 80 includes at least one or more plant substrate walls 89 that define at least one grow deck 88, one or more saddlebags 84 at the base of the plant substrate system 80, and a grow chamber 81. In some hydroponic or aeroponic implementations, plants 303 supported on the at least one grow deck 88 send roots into the grow chamber 81 beneath the at least one grow deck 88. These roots may then be sprayed with water by a nozzle system 90 disposed within grow chamber 81. In other implementations, plants 303 send their roots into soil or other medium such as coco or peat moss.

The horticulture grow system further includes at least a luminaire positioned adjacent to the plant substrate system, the luminaire includes a plurality of grow light panels, a lighting frame, and at least one luminaire connector, the luminaire connector adjusts the spatial position of frame members that define the lighting frame and shape of the luminaire. And wherein the lighting frame includes a plurality of frame members, and wherein the at least one luminaire connector is coupled between one frame member and another frame member adjacent to the one frame member.

In some implementations a luminaire may include a variety of structures, such as a grow light or an led luminaire. In some implementations a luminaire connector includes a variety of structures, such as hinges or adjustable hinges. And in some implementations, a grow light panel may include a variety of structures, such as lighting panel. And in some implementations, a lighting frame may include a variety of structures, such as a curved led lighting frame.

For example, referencing FIGS. 1, 2, 3, 4, 5, and 6, horticulture grow system 1 includes at least luminaire 20 which includes at least s plurality of grow light panels 21, a lighting frame 23, and at least one luminaire connector 29. The at least one luminaire connector 29 is configured to adjust the spatial position of frame members 28 that define the lighting frame 20 and thereby adjust the shape of the luminaire 20. In the above, it is noted that the lighting frame 20 includes a plurality of frame members 28 and the at least one luminaire connector 29 is coupled between one frame member 28 and another frame member 28 adjacent to the one frame member (See, e.g. FIG. 2).

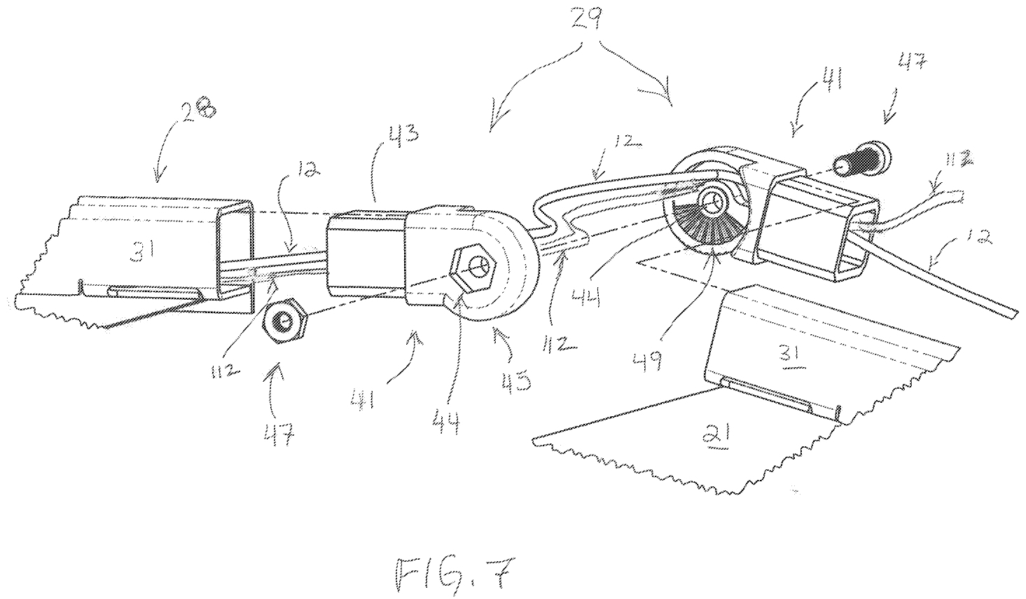

In some further implementations a horticulture grow system further includes at least a power line, the power line coupled to the luminaire, the power line passing through at least one luminaire connector. For example, referencing FIGS. 6 and 7, a power line 12 passes through at least one luminaire connector 29. More specifically referencing FIG. 7, power line 12 is depicted passing within frame member 28 and then passing through two halve portions 41 of luminaire connector 29.

In some further implementations the power line passes in series through the luminaire. For example, in FIG. 6, power line 12 is depicted passing from within frame members 28, through a luminaire connector 29 to within another frame member 28. Thus, in some implementations a single power line 12 passes in series from frame member 28 to frame member 28 of the lighting frame 23. This configures power line 12 to provide power to the plurality of grow light panels 21 coupled with and between the frame members 28. Also, as shown in FIG. 6, power line 12 is powered by a supply line 11, which may be the same wire as power line 12, or a different wire electrically coupled with power line 12.

In some further implementations the power line provides direct current, DC. For example referencing FIG. 11, an electrical schematic, power line 12 provides direct current, DC. This direct current is distributed among the different grow light panels 21 and the associated light units 22. The voltage of the direct current delivered in series to the different light panels 21 is computed by dividing the voltage at the power supply 10 by the number of grow light panels 21 to yield the voltage of direct current provided in series to the individual grow light panels 21. For example, in the example shown in FIG. 11, the supply line 10 has 250 volts of direct current as input power, and there are 5 grow light panels 21. The direct current voltage delivered in series to the grow light panels 21 is therefore 50 volts each.

Thus, in some implementations, a horticulture grow system 1 for plants 303 includes at least a plant substrate system 80, a luminaire 20 positioned adjacent to the plant substrate system 80, the luminaire 20 includes a plurality of grow light panels 21, a lighting frame 23, and at least one luminaire connector 29, the luminaire connector 29 adjusts the spatial position of frame members 28 that define the lighting frame 23 and shape of the luminaire 20 and a power line 12, the power line 12 coupled to the luminaire 20, the power line 12 configured for direct current and passing at least one luminaire connector 29 in series through the luminaire to power one or more grow light panels.

### Exemplary Method

An exemplary method is now described. Preliminarily it is noted that the method includes a plurality of “steps” which are described in a ordered fashion. The order of the steps is merely exemplary and are not intended to limit either this disclosure or the claims. In various implementations, the steps may be performed in different orders and sequences that are different from that described below. Additionally, in the description below, certain elements from the drawings are called out as examples of structure that could, in some implementations, be used to perform the method steps. These called out elements from the drawings are not intended to be limiting.

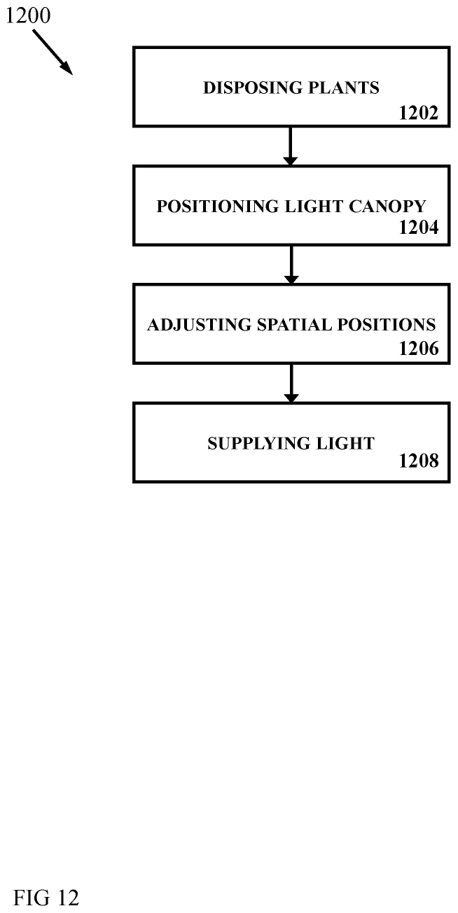

Referencing FIG. 12, in some implementations, an exemplary method 1200 for illumination includes at least the steps described below.

The exemplary method 1200 includes at least disposing plants on a plant substrate system (e.g. plant substrate system 80 of FIG. 1). (Process block 1202) In some implementations the plants are disposed by disposing the plants, for example, in the plant holders 83 of grow decks 89 of plant substrate system 80 such that the roots of the plants descend into grow chamber 81 to be sprayed by nozzle system 90. In other implementations the plants are disposed by disposing the plants in another manner such that the roots are subject to spraying or irrigation without water having to pass through soil or other medium. In other implementations the plants are disposed in soil.

In some implementations the exemplary method 1200 further includes at least positioning a luminaire (e.g. luminaire 20) adjacent to the plant substrate system (e.g. plant substrate system 80) to define a plant canopy zone (e.g. plant canopy zone 118 of FIG. 1). (Process block 1204) As used herein adjacent includes close enough to provide a sufficient amount of beneficial light on plants disposed in plant holders 83 of grow decks 88, but far enough to allow for a plant canopy zone 118 and to be able to direct light at grow decks 88 of the plant substrate system 80.

In some implementations, positioning a luminaire per Process block 1204 includes at least positioning a luminaire (e.g. luminaire 20) that includes a plurality of grow light panels (e.g. grow light panels 21), a lighting frame (e.g. lighting frame 23) having a plurality of frame members (e.g. frame members 28) and at least one luminaire connector (e.g. luminaire connector 29).

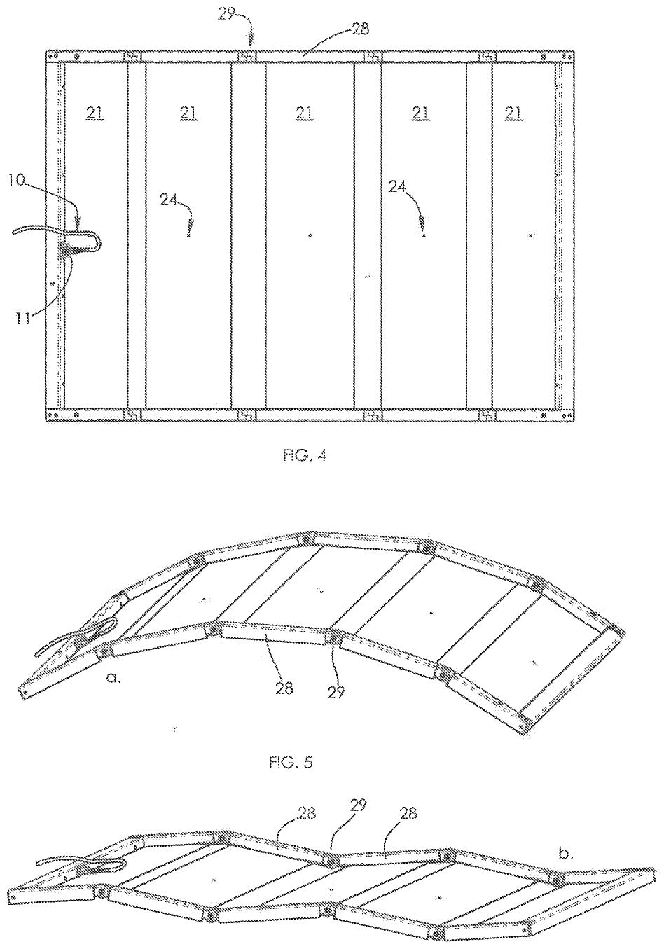

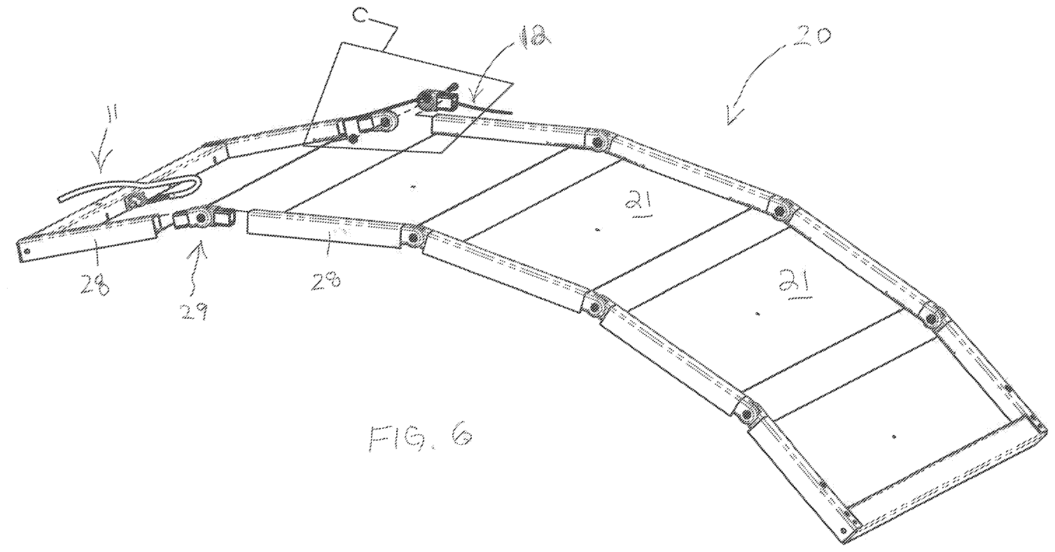

In some implementations the exemplary method 1200 further includes adjusting the spatial positions of frame members (e.g. frame members 28) of the plurality of frame members to render the luminaire (e.g. luminaire 20) in a shape (See, e.g. shape of luminaire 20 in Drawing 5a of FIG. 5). (Process block 1206) For example, spatial positions of frame members (e.g. frame members 28) starting as shown if Drawing 5b of FIG. 5 (e.g. straight or irregular) may be adjusted to be as shown in Drawing 5a. The adjustment may be performed at least in part by using the luminaire connectors (e.g. luminaire connectors 29) to adjust the spatial positions of the frame members (e.g. frame members 28) to achieve the shape of, for example, Drawing 5a (e.g. curvilinear).

And in some implementations, the exemplary method 1200 further includes supplying light to the plants within the plant canopy zone (e.g. plant canopy zone 118 of FIG. 1) with the luminaire (e.g. luminaire 20) rendered in a shape (See, e.g. shape of luminaire 20 in Drawing 5a of FIG. 5). (Process block 1208).

In some implementations, supplying light to the plants per process block 1208 includes at least passing a power line (e.g. power line 12) in series through the lighting fame (e.g. lighting frame 23) to illuminate the plurality of grow light panels (e.g. grow light panels 21). In some further implementations, as shown in FIG. 7, a power line (e.g. power line 12) passes from within one frame member (e.g. frame member 28) to another frame member via a passage in a luminaire connector (e.g. luminaire connector 29). In some implementations the power line 12 passes direct current DC.

It will be understood by those skilled in the art that the terminology used in this specification and in the claims is “open” in the sense that the terminology is open to additional elements not enumerated. For example, the words “includes” should be interpreted to mean “including at least” and so on. In addition, articles such as “a” or “the” should be interpreted as not referring to a specific number, such as one, unless explicitly indicated. At times a convention of “at least one of A, B, or C” is used, the intent is that this language includes any of A alone, B alone, C alone, A and B, B and C, A and C, or all of A, B, and C. The same is indicated by the conventions “one of more of A, B, or C.” Similarly, the phrase “A, B, and/or C” is intended to include any of A alone, B alone, C alone, A and B, B and C, A and C, or all of A, B, and C. With parentheticals such as (e.g. A, B, C). It is intended that this refer to any or all of A alone, B alone, or C alone and to any combination thereof that is applicable in the particular context.

And as previously indicated elements, components, or operations should not be regarded as essential unless they are so explicitly described. The teachings contained herein may be adapted to a variety of implementations arranged and composed in a wide variety of ways.

The above description of various implementations is intended to be illustrative not exhaustive and is not intended to limit this disclosure, its application, or uses. Those skilled in the art will be able to imagine implementations not described but that are consistent with the principles and teachings described herein. Therefore, the above description of exemplary implementations is not intended to limit the scope of this disclosure, which should be defined only in accordance with the following claims and equivalents thereof.

We claim:

1. A horticulture grow system for plants comprising:
a plant substrate system;
a luminaire positioned adjacent to the plant substrate system, the luminaire includes a plurality of grow light panels, a lighting frame, and at least one luminaire connector, the lighting frame includes a plurality of frame members, the at least one luminaire connector is coupled between one frame member and another frame member adjacent to the one frame member, the luminaire connector adjusts the spatial position of the plurality of frame members that define the lighting frame and shape of the luminaire; and
a plant canopy zone, defined between the plant substrate system and the luminaire, and
whereby the plant canopy zone defines a space for illuminating the plants.

2. The horticulture grow system for plants of claim 1, wherein the luminaire connector configured to rotationally adjust the spatial position of each adjacent frame member.

3. The horticulture grow system for plants of claim 1, wherein each frame member of the plurality of frame members comprise tubing having a corresponding frame wall.

4. The horticulture grow system for plants of claim 1, wherein the luminaire connector includes a connector adjustment.

5. The horticulture grow system for plants of claim 1, further comprising a supply line, the supply line coupled to the luminaire.

6. The horticulture grow system for plants of claim 5, wherein the supply line includes a power line, the power line coupled to the luminaire.

7. The horticulture grow system for plants of claim 6, wherein the power line passing through the at least one frame member and the another frame member adjacent to the at least one frame member.

8. The horticulture grow system for plants of claim 7, wherein the power line passes through the at least one luminaire connector.

9. The horticulture grow system for plants of claim 7, wherein the power line provides direct current, DC.

10. The horticulture grow system for plants of claim 7, wherein the power line passing though the plurality of frame members in series.

11. The horticulture grow system for plants of claim 5, wherein the supply line provides control signals to the luminaire.

12. The horticulture grow system for plants of claim 5, further comprising a nozzle system, wherein the supply line provides control signals to the nozzle system.

13. The horticulture grow system for plants of claim 1, further comprising an actuator, the luminaire connector includes a first half portion and a second half portion, the actuator positioned between the first half portion and second half portion and coupled to the supply line, the actuator receives control signals to render the first and second half portions from a first spatial position to a second spatial position.

14. A horticulture grow system for plants comprising:
a plant substrate system;
a luminaire positioned adjacent to the plant substrate system,
the luminaire includes a plurality of grow light panels, a lighting frame, and at least one luminaire connector, the luminaire connector adjusts the spatial position of frame members that define the lighting frame and shape of the luminaire; and
a power line, the power line coupled to the luminaire, the power line configured for direct current and passing at least one luminaire connector in series through the luminaire to power one or more grow light panels.

15. The horticulture grow system for plants of claim 14, wherein the lighting frame includes a plurality of frame members, and wherein the at least one luminaire connector is coupled between one frame member and another frame member adjacent to the one frame member.

16. A method for illumination comprising the steps of:
disposing plants on a plant substrate system;
positioning a luminaire adjacent to the plant substrate system to define a plant canopy zone, the luminaire includes a plurality of grow light panels, a lighting frame having a plurality of frame members, and at least one luminaire connector;
adjusting the spatial positions of frame members of the plurality of frame members to render the luminaire in a shape; and
supplying light to the plants within the plant canopy zone with the luminaire rendered in a shape.

17. The method for illumination of claim 16, wherein in the step of supplying light to the plants includes passing a power line in series through the lighting fame to illuminate the plurality of grow light panels.
